(19) United States
(12) Patent Application Publication
(10) Pub. No.: US 2010/0174669 A1
(43) Pub. Date: Jul. 8, 2010

(54) Method of operating a micro-environment within a commercial complex to promote sales of goods and/or services offered for sale by participating retail merchants

(76) Inventor: Roy Higgs, Severna Park, MD (US)

Correspondence Address: Patent Office of J. John Shimazaki, PLLC, P.O. Box 650741, Sterling, VA, 20165, US

(21) Appl. No.: 12/590,960

(22) Filed: Nov. 17, 2009

Related U.S. Application Data
(63) Continuation-in-part of application No. 10/657,693, filed on Sep. 8, 2003, now abandoned.
(60) Provisional application No. 60/408,334, filed on Sep. 6, 2002.

(51) Int. Cl. G06Q 90/00

(52) U.S. Cl. 705/500

(57) ABSTRACT

The invention relates to a method of operating a microenvironment located within a common area of a shopping mall adapted to promote the particular goods and/or services offered for sale by one or more participating retail merchants leasing space adjacent to or near the microenvironment. One or more activities can be conducted in the microenvironment including allowing the participating merchant's potential customers to use, try and/or sample the particular products and/or services offered for sale by the merchants, as a means of promoting those goods and/or services, and attracting customers generally to the shopping mall.

### RELATED APPLICATIONS

This application is a continuation in part of U.S. application Ser. No. 10/657,693, which was filed on Sep. 8, 2003, which claims priority from U.S. Provisional Application Ser. No. 60/408,334, filed on Sep. 6, 2002. Both applications are incorporated herein by reference.

### FIELD OF THE INVENTION

The present invention relates to operating methods, and in particular, to a method of operating a physical microenvironment within a commercial complex, such as a shopping mall, to provide activities including entertainment designed to promote the particular goods and/or services offered for sale by participating retail merchants.

### BACKGROUND OF THE INVENTION

While there are many large mass retail merchandize stores, such as Walmart®, Target®, Kmart®, etc., and large department stores, such as Macy's®, Bloomingdales®, Hechts®, etc., that sell a wide variety of consumer goods, many smaller retail merchants have to specialize to set themselves apart from the rest. For example, in shopping malls across the country, there are many specialty stores that sell specific types of consumer goods, such as clothing, shoes, books, furniture, cookware, dishes, sporting goods, toys, etc. These establishments specialize in and deal with particular goods and are able to provide merchandize of a specialized nature as a means of attracting customers to their stores.

Developing a marketing strategy that includes specialization often includes promoting products and services in a unique way to focus on the differences between the specialized products and other more general products. Many such retail establishments spend considerable time, money and effort creating concepts and images for branding purposes, and then conveying those concepts and images to consumers through advertising and other marketing methods to attract consumers to their stores. This can be done, for example, by using the decor of the store itself, including the style, design, colors, etc., so that consumers who are interested in those styles, etc., will be drawn to the establishment. In this respect, the décor is often designed to be compatible with the products and services that are offered at the establishment.

Another method that some retail establishments use, in addition to specialization, is offering activities that are related to the products and services offered by the stores as a means of attracting new customers. For example, a cookware store might offer cooking classes, and an arts supply store might offer art classes. Stores have also begun to provide entertainment to attract customers. For example, McDonalds® has children's playgrounds in many of their restaurants to encourage parents to bring their kids as well as to hold birthday parties, etc., and other events there. Rain Forest Café® and Chuck E Cheese® have animated characters and other forms of entertainment to attract consumers. Sporting goods stores, such as Galyans®, have rock climbing walls, while others have indoor skiing facilities, etc.

Entire shopping malls can also provide activities and entertainment to attract customers. For example, movie theaters are commonly found in large shopping malls to attract customers. Some large malls even have roller coaster rides and other attractions, while others have built-in playgrounds, and put on free concerts, exhibits, and galleries, etc. During Christmas time, malls typically have extensive decorations, Christmas trees, and Santa Claus, all designed to attract more customers.

One of the drawbacks of previous attempts like these have been that the activities and entertainment have not necessarily been targeted to promote the particular products and services that are offered for sale by the retail merchants located at the mall. In many cases, the entertainment is provided generally to attract people to the mall, but not necessarily to promote any particular goods or services of a particular retail merchant. Accordingly, consumers often simply come for the entertainment or activity, and end up not buying the products and services offered by the retail merchants. Moreover, while some large retail stores (such as those that are not located in shopping malls) are able to conduct promotional activities of their own, inside their own stores, many smaller retail merchants that occupy and lease space in shopping centers and malls don't have the resources or the space to offer these activities on their own.

What is needed, therefore, is a method of operating a physical micro-environment within a commercial complex, such as a shopping center or mall, designed to provide activities and other forms of entertainment that are specifically designed to promote the products and services being offered for sale by the participating retail merchants, wherein the activities can be used to attract customers to the commercial complex, but also to help promote sales of the specific products and services that the retail merchants offer.

### SUMMARY OF THE INVENTION

The present invention relates to a method of promoting sales of particular goods and/or services offered for sale by particular retail establishments within a retail complex, such as a shopping mall or center, comprising the use of a physical micro-environment within the complex having a theme associated with the particular goods and/or services offered for sale by the participating retail merchants. From this point, the term “shopping mall” will be used to describe all such retail complexes, including indoor and outdoor shopping malls, shopping centers, etc. The invention contemplates that the micro-environment can preferably be located within the common area of the shopping mall adjacent to or in close proximity to the participating retail establishments, and not inside the stores themselves, and that at least one activity is conducted within the micro-environment designed to promote at least one particular good and/or service offered for sale by those retail merchants. This way, the designated activity can not only entertain and attract customers to the shopping mall generally, but it can also provide a means of promoting the particular goods and/or services offered for sale by those participating retail merchants.

An example of the present invention relates to a micro-environment within a common area of the shopping mall having a theme that relates to the products and/or services of at least two retail merchants that are located adjacent to or near the micro-environment. For example, in a shopping mall, a micro-environment can be developed in connection with a theme relating to sports and outdoor activities, wherein adjacent to the micro-environment, there can be a sporting goods store, an outdoor clothing store, and/or other specialty stores that sell various outdoor sporting equipment, such as skate boards, surf boards, snow boards, sunglasses, beachwear, etc. Likewise, the micro-environment can comprise of, without limitation, any one or more of the following activities: a rock climbing wall, a putting green, a golf driving range or net, a wave pool, a wave machine, a skate park, an off-road vehicle course, a simulated skiing machine, a simulated surf machine, a swim exercise pool, an underwater diving tank, an ice skating rink, a basketball court, an exhibition hall, a theater showing specific themed movies, a ride tailored to related subjects, etc. In such case, the sporting goods store, as well as the specialty stores, and other associated retail establishments, can have at least one of their goods and/or services available to be used, tried and/or sampled by potential customers of those retail merchants, wherein the retail merchants can use the microenvironment to enable specific products and/or services to be used, tried and/or sampled, while potential customers are participating in and enjoying the activities.

In another embodiment, a retail merchant that offers specific services could be located adjacent to or near the microenvironment, wherein the services offered by the merchant can be promoted by the activity. For example, an outdoor excursion business can be provided, wherein lessons and other information relating to various types of excursion activities can be provided in the microenvironment as a means of attracting customers to the business, i.e., an employee of the business can, for instance, offer rock-climbing lessons at the rock-climbing wall as a means of promoting their rock climbing excursion adventures.

The microenvironment can also be altered during different seasons. In the above example, the rock climbing wall, putting green, indoor golf driving net, swim exercise pool, and underwater diving tank, can be offered during the summer months, while the simulated skiing and ice skating rink can be offered during the winter months. This way, the microenvironment can be geared specifically towards the particular goods and/or services that are likely to be popular during any given time of year.

The microenvironment contemplated herein is different from other promotional programs that have been implemented in the past, such as those that are operated within a particular retail establishment, in that the present invention is intended to be operated within a common area of the shopping mall, i.e., not within the retail stores themselves, as a means of attracting potential customers to the mall, as well as to promote the particular goods and/or services offered for sale by the participating nearby retail merchants.

The microenvironment is also different from other temporary or limited duration promotional programs such as those that are often conducted only during the holidays or for a few weeks out of the year, in that the present microenvironment is intended to be a physical fixture or structure or otherwise a permanent establishment that exists within the common area of the shopping mall, wherein the activities conducted there could be operated throughout the entire year, i.e., 365 days out of the year when practical. While the activities can be modified from time to time, i.e., such as from season to season, as discussed, the intent would be that the activities in the microenvironment could be conducted as often as possible, taking into account the need to shutdown the facility while the microenvironment or activity is being modified.

The present invention also contemplates that mall developers can use the microenvironment as a means of attracting the right kind of retail merchants to the mall. That is, in any development, mall developers will have a strong interest in attracting the right kind of retail merchants to occupy and lease space at the mall, since the quality of the tenants will largely dictate the quality of the overall shopping experience for the consumer, and therefore, the success of the development. By being able to offer a microenvironment within a shopping mall specifically designed to promote the particular products and/or services that are being offered for sale by the desired retail merchants, mall developers can attract and encourage the desired type of merchants to occupy and lease retail space at the mall. The merchants would presumably have an interest in using the microenvironment to promote their products and/or services, since it can be specifically tailored to their businesses as appropriate.

### BRIEF DESCRIPTION OF THE DRAWINGS

FIG. 1 shows an example of an indoor/outdoor application of a microenvironment of the present invention in a shopping mall environment.

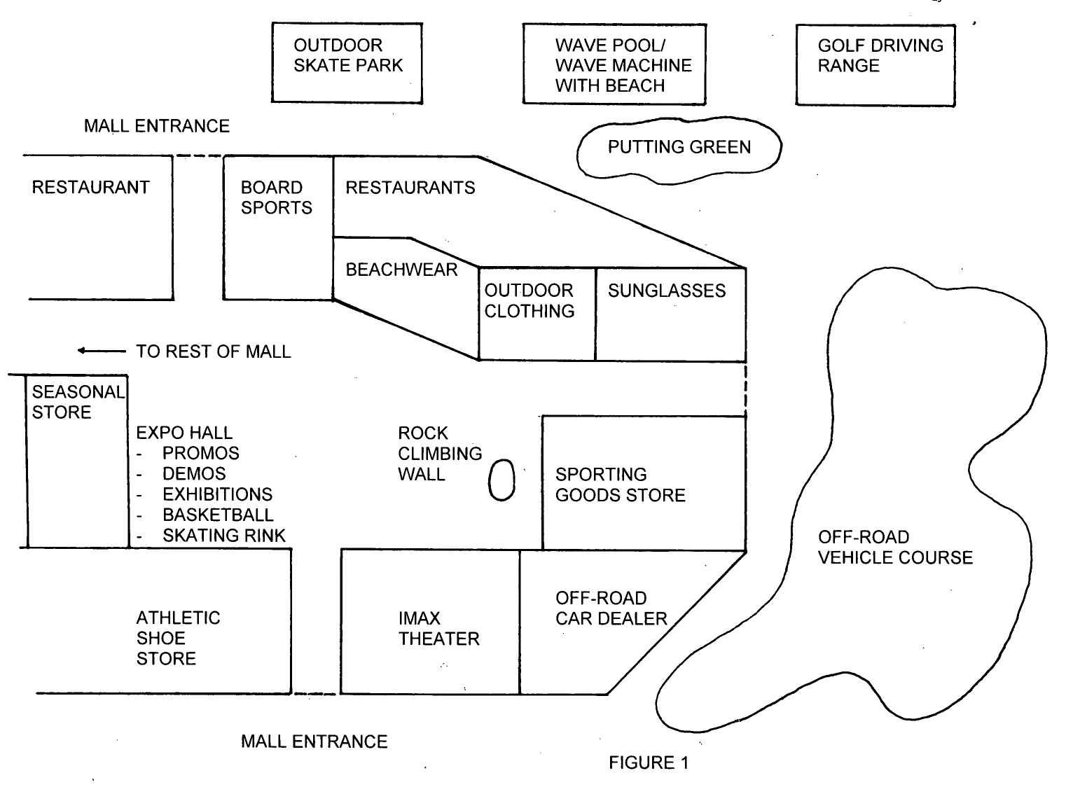

### DETAILED DESCRIPTION OF THE INVENTION

The development of a shopping mall typically involves a complex series of events that must be coordinated for the development to be successful. To the average consumer, there is no indication on the outside of the enormous amount of time, effort and resources that are required to enable a shopping mall to be developed and operated.

In the beginning, there must be a vision, and enough talent and resources to get the project off the ground. The initial steps, in many cases, begin with the mall concept, as well as the selection of a location. Marketing studies are often performed to determine the best location, as well as what kinds of retail establishments should occupy retail space at the mall. These decisions are often based on geographical and demographical marketing statistics and other information about the kinds of communities that will eventually be located near the mall, as well as the economic statuses of the consumers who will likely shop there. Various studies relating to the economic conditions and wealth statuses of the area, including future prospects for employment and growth, are likely to be conducted. Specific studies relating to various zoning and density requirements, ordinances, easements, environmental impacts, availability of utilities, transportation, roads and services, land use restrictions, etc. are also typically considered. Permission from government agencies and boards, as well as political groups, is also often required.

These are just some of the issues that must be dealt with in developing a shopping mall. There are also a number of financial issues, including how the cost of the project is going to be financed and by whom. This could involve obtaining loans from financial institutions or obtaining funding from investors, whether they are individuals or companies. When obtaining money from investors, decisions will often have to be made, and disclosures will often have to be given, with respect to how the costs and benefits will be apportioned and spent. Other decisions that have to be made include deciding who the contractors and sub-contractors are going to be, which can involve obtaining quotes and bidding the project to potential contractors. Specifications, in such case, such as developed by a design firm responsible for the architectural and engineering drawings and designs, as well as city and regional planning issues, will also have to be created.

Another issue that mall developers have to deal with involves selecting the right type of retail merchants that are going to occupy and lease retail space at the mall. This process can be complicated by the fact that negotiations often have to be entered into with respect to each prospective tenant in advance, and each one presumably has its own interests and concerns that must be considered and discussed. Some prospective tenants may be essential to the mall, such as large department stores, which may be the focus of the initial development efforts. For example, in any given mall, the fact that Nordstrum, Macy's, Saxs Fifth Avenue, etc., might agree to occupy space at the mall could change the entire complexion of the development, both from the standpoint of the size and scope of the construction, as well as who the other tenants might be. As is often the case, a decision by one tenant may end up being the reason that another tenant might agree to lease space there. Various agreements would also have to be entered into in order to assure that the right kinds of tenants will occupy and lease retail space at the mall. The decision whether to occupy space at a particular mall, and the extent of their involvement, will ultimately be decided upon by the retail merchants themselves.

Within this context, mall developers have a number of important options and decisions to make concerning the development of the mall. They often have to deal with the prospect that they can't always control who the tenants will be, nor other factors relating to the mall's development.

The present invention contemplates that mall developers will be able to attract prospective and desirable retail tenants by providing a microenvironment within the mall specifically designed to provide activities including entertainment that can help promote the particular goods and/or services offered for sale by the participating retail merchants. The activities are also intended to be entertaining and enjoyable on their own, to attract customers to the mall generally.

For example, if mall developers want to have a sporting goods store located in the mall, they can improve the chances of attracting the right kind of sporting goods store by offering a package that includes the construction of a micro-environment within the common area of the mall which can be used by the retail merchant to promote the specific kinds of goods and/or services that they sell. By being located in the common area, the microenvironment, and therefore, the activities conducted there will not take away from the retail merchant's store space or interfere with its sales activities.

An example might be the construction of a rock climbing wall inside the common area of the shopping mall, adjacent to where the sporting goods store will be located, wherein consumers who want to climb the wall will be able to use, try and/or sample a wide variety of products, such as rock climbing gear, shoes, ropes, etc., that are offered for sale by the sporting goods store. This way, potential customers may come to the mall to enjoy the rock-climbing wall, and then, after sampling the products offered for sale by the stores, they may end up buying some of the products that they tried. They might also end up buying other products offered for sale by the same stores as a result. Another example is a golf driving range and/or miniature golf putting green located adjacent to a sporting goods store, wherein consumers can try out the latest types of golf clubs before deciding which ones to buy at the store.

Additional retail merchants that stand to benefit from the activity conducted at the microenvironment, such as outdoor clothing and excursion guide businesses, and other specialty stores, can also be located adjacent to or near the micro-environment, so that by operating the activity in the common area, the mall can help promote the specific products and/or services offered for sale by the participating retail merchants. The fact that developers can offer this type of service may help them attract the right kind of retail merchants who will have more of an incentive to lease space at that mall.

In one aspect, the present invention relates to a method of operating a physical microenvironment within a common area of a shopping mall in an effort to promote the goods and/or services offered for sale by particular retail merchants located adjacent to or near the microenvironment, wherein various activities are contemplated that can be conducted within the micro-environment, wherein the activities can also have a theme associated with the goods and/or services offered for sale by the participating retail establishments. The invention contemplates that the micro-environment can be located within the common areas of the shopping mall, including indoor and outdoor areas, adjacent to or near the participating retail merchants, so that an immediate association can be made in the minds of consumers between the activity and the associated merchants. For example, at least one activity can be provided within the microenvironment that matches the branding of the particular goods and/or services offered for sale by a particular retail merchant. This way, the activity can not only provide entertainment to attract customers to the mall, but it can also enable participating retail merchants to promote the particular goods and/or services that they sell.

Another example is a micro-environment having a theme that is associated with at least two retail merchants located within the mall, i.e., adjacent to or near the micro-environment. For example, in a shopping mall, the micro-environment can have a sports or outdoor theme, wherein adjacent to or near the micro-environment there can be a sporting goods store, an outdoor clothing store, and other specialty stores tailored to specific outdoor activities. The activities provided in the micro-environment can, in turn, be one or more of the following: a rock climbing wall, a putting green, a golf driving range or net, a wave pool, a wave machine, a skate park, an off-road vehicle course, a simulated skiing machine, a simulated surf machine, a swim exercise pool, an underwater diving tank, an ice skating rink, a basketball court, an exhibition hall, a theater showing specific themed movies, a ride tailored to related subjects, etc. In this respect, the invention contemplates that specialty stores, such as those that sell skate boards, snow boards, surf boards, sunglasses, beachwear, and other paraphernalia, could also be located adjacent to or near the micro-environment. In such case, the sporting goods store can allow sports equipment that they sell to be used, tried and/or sampled, while certain specialty stores can allow their potential customers to use, try and/or sample their products and/or services as well.

Merchants that offer services can be located adjacent to or near the microenvironment, wherein the services can be promoted by the activity that is conducted there. For example, in connection with the above-identified activities, an outdoor excursion guide business can be located in close proximity to the microenvironment, wherein lessons and other information relating to the activities can be provided as a means of promoting the business. An employee of the business can offer, for instance, rock-climbing lessons at the rock-climbing wall as a means of promoting their rock-climbing excursion adventures.

The microenvironment can also be located in an outdoor area of the mall property. For example, in the above example, a variety of outdoor activities can be provided outside near the participating retail merchants. For instance, the mall could incorporate an outdoor skate park near the sporting goods store, or a golf driving range or putting green near the golf shop, or an off-road vehicle course, such as the one in pending application No. 60/426,380, filed by Applicant on Nov. 15, 2002, which can be located near an automobile dealership. The microenvironment could also have an indoor or outdoor skating rink, or wave surfing machines and wave pools, etc. Any one of the activities described above, as well as other activities, can be provided as part of an indoor/outdoor microenvironment. The present invention contemplates that the microenvironment can be located indoors, outdoors, or in both. Depending on the climate, all of the activities could be provided outdoors if desired.

The microenvironment can also be altered during different seasons of the year. In the above example, the golf driving range, putting green, wave pool, skate park, etc., can be offered during the summer months. On the other hand, the simulated skiing and ice skating rink can be offered during the winter months. This way, the microenvironment can be geared specifically towards the particular goods and/or services that are likely to be offered for sale during any given time of year. Any of various activities can be rotated through different times of the year, including the seasons, depending on what kinds of goods and/or services are to be promoted.

The microenvironment contemplated herein is intended to be operated as an ongoing activity throughout the year, and in that respect, differs from temporary or limited duration promotional programs that may operate during the holidays or for only a few weeks out of the year. The present microenvironment is intended to be a physical structure or fixture or otherwise a permanent establishment within the common area of the shopping mall, wherein the activities conducted there could operate throughout the entire year, i.e., 365 days out of the year when practical. While the activities can be modified from time to time, i.e., such as from season to season, the intent is that the activities could be conducted as often as possible throughout the entire year, taking into account the need to shutdown the facility to change the activity or structure, etc.

The microenvironment is also different from other promotional programs that have been implemented in the past, including those that are operated inside a particular retail establishment. This is because the microenvironment of the present invention is intended to be operated within a common area of the shopping mall, i.e., not within the retail stores themselves, as a means of attracting potential customers to the mall, as well as promoting the particular goods and/or services offered for sale by the participating merchants.

The present invention contemplates that virtually any activity that is consistent with a chosen theme that relates to the particular products and/or services being offered for sale by the participating retail merchants can be provided. Other examples include the following: fashion design and make-up activities in close proximity to clothing and beauty supply stores; concerts and musical activities in close proximity to stores that sell cd's, tapes and/or musical instruments; cooking and tasting displays in close proximity to cookware and unique food stores, etc.

The present invention contemplates that the microenvironment can be independently operated by a separate business within the shopping mall, or it can be operated by the shopping mall, or by one or more of the retail merchants that occupy and lease space at the mall, individually or collectively, depending on what the merchants want to do.

Another aspect of the invention is that the retail merchants that occupy and lease retail space adjacent to or near the microenvironment can be those that are not ordinarily retail merchants, but product manufacturers and producers with recognizable brand names that normally sell their products through other retail stores. For example, a company that makes and sells designer sunglasses might ordinarily sell their products through department stores and other specialty sunglass stores, but what the microenvironment allows the mall developer to do is to attract these types of manufacturers and producers that would not ordinarily operate a retail establishment and give them an incentive to occupy and lease retail space at the mall. One incentive is that the activities in the microenvironment can help promote their particular products and/or services. Another is that the producer of the product would stand to earn the full mark-up price on each product sold, i.e., by avoiding the retail margin that would otherwise be given to the retail merchant.

The present invention has been described in terms of the preferred embodiments discussed above, but it is contemplated that other embodiments not specifically discussed herein are also within the contemplation of the present invention.

What is claimed is:

1. A method of operating a microenvironment within a shopping mall and promoting sales of goods and/or services using said microenvironment, comprising:
allowing at least one retail merchant to occupy and lease at least one retail space in said shopping mall;
providing a physical microenvironment and locating it within a common area of said shopping mall separate from said retail space;
providing at least one activity within said microenvironment and allowing at least one good and/or service offered for sale by said retail merchant to be used, tried and/or sampled by potential customers of said retail merchant, wherein said activity is designed to promote the sale of said good and/or service offered for sale by said retail merchant and attract patrons to said shopping mall; and
making said at least one activity an ongoing and continuous activity of said shopping mall.

2. The method of claim 1, wherein at least two merchants are allowed to occupy and lease retail space at said shopping mall, and said at least one activity enables said two retail merchants to promote their goods and/or services by allowing potential customers to use, try and/or sample their goods and/or services.

3. The method of claim 1, wherein said microenvironment is located in an indoor and/or outdoor area of said shopping mall.

4. The method of claim 1, wherein said at least one activity is taken from the group consisting of the following:
a. sports and/or other outdoor activities;
b. fashion design and/or make-up activities;
c. concerts and/or musical activities;
d. cooking and/or tasting displays.

5. The method of claim 1, wherein said at least one activity is independently operated by a separate business within said shopping mall.

6. The method of claim 1, wherein said at least one activity within said microenvironment or said microenvironment is altered during the year to emphasize themes associated with different seasons of the year.

7. The method of claim 1, wherein said at least one activity comprises one or more activities taken from the group consisting of the following: a rock climbing wall, a putting green, a golf driving range or net, a wave pool, a wave machine, a skate park, an off-road vehicle course, a simulated skiing machine, a simulated surf machine, a swim exercise pool, an underwater diving tank, an ice skating rink, a basketball court, an exhibition hall, a theater showing specific themed movies, a ride tailored to related subjects, fashion design and make-up activities, concerts or musical activities, and cooking and tasting activities and displays.

8. A method of operating a microenvironment within a shopping mall and promoting sales of goods and/or services using said microenvironment, comprising:
allowing at least two retail merchants to occupy and lease retail space in said shopping mall;
providing a physical microenvironment and locating it within a common area of said shopping mall separate from said retail space leased by said retail merchants;
providing at least one activity within said microenvironment and allowing at least one good and/or service offered for sale by said retail merchants to be used, tried and/or sampled by potential customers of said retail merchants, wherein said activity is designed to promote the sale of said good and/or service offered for sale by said retail merchants; and
making said at least one activity an ongoing activity of said shopping mall.

9. The method of claim 8, wherein said microenvironment is located in an indoor and/or outdoor area of said shopping mall.

10. The method of claim 8, wherein said at least one activity is taken from the group consisting of the following:
a. sports and/or other outdoor activities;
b. fashion design and/or make-up activities;
c. concerts and/or musical activities;
d. cooking and/or tasting displays.

11. The method of claim 8, wherein said at least one activity is independently operated by a separate business within said shopping mall.

12. The method of claim 8, wherein said at least one activity within said microenvironment or said microenvironment is altered during the year to emphasize themes associated with different seasons of the year.

13. The method of claim 8, wherein said at least one activity comprises one or more activities taken from the group consisting of the following: a rock climbing wall, a putting green, a golf driving range or net, a wave pool, a wave machine, a skate park, an off-road vehicle course, a simulated skiing machine, a simulated surf machine, a swim exercise pool, an underwater diving tank, an ice skating rink, a basketball court, an exhibition hall, a theater showing specific themed movies, a ride tailored to related subjects, fashion design and make-up activities, concerts or musical activities, and cooking and tasting activities and displays.

14. A method of operating a microenvironment within a shopping mall and promoting sales of goods and/or services using said microenvironment, comprising:
providing a microenvironment within a common area of said shopping mall and incorporating said microenvironment physically in said common area;
allowing at least one retail merchant to occupy and lease a retail space within said shopping mall, wherein said retail space is separate from said microenvironment;
providing at least one activity within said microenvironment and allowing at least one good and/or service offered for sale by said retail merchant to be used, tried and/or sampled by potential customers of said retail merchant; and
providing a different activity in said microenvironment to promote a different good and/or service during a different time of the year.

15. The method of claim 14, wherein at least two merchants are allowed to occupy and lease retail space at said shopping mall, and said at least one activity enables said retail merchants to promote their goods and/or services by allowing potential customers to use, try and/or sample at least one good and/or service.

16. The method of claim 14, wherein said microenvironment is located in an indoor and/or outdoor area of said shopping mall.

17. The method of claim 14, wherein said at least one activity is taken from the group consisting of the following:
a. sports and/or other outdoor activities;
b. fashion design and/or make-up activities;
c. concerts and/or musical activities;
d. cooking and/or tasting displays.

18. The method of claim 14, wherein said at least one activity is independently operated by a separate business within said shopping mall.

19. The method of claim 14, wherein said at least one activity comprises one or more activities taken from the group consisting of the following: a rock climbing wall, a putting green, a golf driving range or net, a wave pool, a wave machine, a skate park, an off-road vehicle course, a simulated skiing machine, a simulated surf machine, a swim exercise pool, an underwater diving tank, an ice skating rink, a basketball court, an exhibition hall, a theater showing specific themed movies, a ride tailored to related subjects, fashion design and make-up activities, concerts or musical activities, and cooking and tasting activities and displays.

20. The method of claim 14, wherein said at least one activity within said microenvironment or said microenvironment is altered during the year to emphasize themes associated with different seasons of the year.
